(19) United States
(12) Patent Application Publication
(10) Pub. No.: US 2017/0059248 A1
(43) Pub. Date: Mar. 2, 2017

(54) REFRACTORY CERAMIC BRICK COMPOSITE

(71) Applicant: Refractory Intellectual Property GmbH & Co. KG, Wien (AT)

(72) Inventors: Bernd Handle, Wien (AT); Bojan Zivanovic, Wien (AT)

(73) Assignee: Refractory Intellectual Property GmbH & Co. KG, Wien (AT)

(21) Appl. No.: 15/120,041

(22) PCT Filed: Feb. 24, 2015
(86) PCT No.: PCT/EP2015/053833

§ 371 Date: Aug. 18, 2016

(30) Foreign Application Priority Data
Apr. 10, 2014 (EP) 14164258.7

(51) Int. Cl. F27D 1/00

(52) U.S. Cl. CPC F27D 1/0023; F27D 1/0006

(57) ABSTRACT

The invention relates to a refractory ceramic brick assembly. In other words: The subject of the invention relates to a multiplicity of refractory ceramic bricks which are arranged to one unit in a specific way, i. e. combined with each other.

The invention relates to a refractory ceramic brickwork assembly. In other words: the subject of the invention relates to multiple refractory ceramic bricks which are assembled into a unit in a specific way, and thus connected to each other.

Refractory ceramic bricks particularly serve as linings for furnace aggregates, for example vessels for the treatment of metal melts. The following description of the bricks and the brickwork is, if not displayed otherwise, as follows:
The bricks and the brickwork are described in their new condition (without any wear)
The description starts at the front, from the inside of the corresponding vessel, so that a frontal face of the brick describes the side which is adjacent to the furnace chamber. Correspondingly the respective rear surface of the bricks is adjacent to an outer wall of the furnace vessel.
The term “row” includes at least two bricks arranged horizontally adjacent to each other. This principle is analogously valid for rows of bricks which are extending vertically and therefore, by definition, subsumed under the term “row”. A cuboidal brick is defined by six surfaces wherein two opposite surfaces are always rectangular and of the same size. Therefore all angles are generally right angles. However bricks in the brickwork according to this invention can also be wedged in at least one direction of the coordinate system.
Directions such as up, down, right and left correspond to a normal coordinate system.
All dimensions/geometric details are (for example regarding the manufacturing tolerances) to be viewed in a technical way and not exactly mathematically.

A vessel lined with refractory ceramic bricks, where some bricks are shaped and arranged in such a way that their degree of wear can be detected from the front, is knows from GB 2 000 579 A

For this purpose bricks are used which each feature a slanted side face between two parallel front and rear faces. The two bricks are laid in a form fitting manner between their two slanted side faces. The degree of wear is revealed by movement of the joint of the two slanted side faces.

This prior art solution however only allows for an empirical determination of the degree of wear. Therefore it cannot be reliably detected if for example ¼ or ¾ of the brick's thickness (between the front and rear face) is worn away. Respectively it can only be empirically detected if the lining needs to be replaced or not.

The invention underlies the object to provide a wear indicator for refractory bricks which allows for a quantative determination of the degree of wear.

The solution to this problem originates from the following thought, based on the subject of GB 2000579 A:

In order to make the “movement of the joint” with increasing wear of the bricks more visible, the respective bricks are shifted by 90° in relation to the rest of the lining. Furthermore the bricks with slanted side faces are arranged between two continuous bricks of the large format.

The “movement of the joint” (the lateral movement of the joint) with an increase in wear is dependent on the angle between the front face and the side face of the bricks. This angle is generally unknown. Correspondingly the degree of wear cannot be determined in a quantitative manner.

In contrast, the invention suggests to arrange the joint between the slanted faces of two adjacent bricks offset to at least one joint of a row of bricks arranged below or above, wherein these adjacent row of bricks consists of bricks of a format where the joints between the bricks generally remain in the same place (from a frontal perspective), independent of the degree of wear of these bricks.

Thus the distance between the joints of adjacent rows of bricks changes in the case of wear. This can be mathematically adjusted so that the moving joint of one row of bricks is aligned with the fixed joint of an adjacent row of bricks when the bricks have reached a certain degree of wear, for example the maximum degree of wear where the bricks shall be replaced.

By the means of certain adaptations multiple reference joints in adjacent rows of bricks can be formed in order to show different degrees of wear, for example ¼, ½, or ¾ of the maximum degree of wear or ⅓, ⅔ or ⅕, ⅖, ⅗, ⅘, 5/5.

The position of the joints of adjacent rows of bricks within the brickwork can be easily analysed visually. Special measurement devices are not required. The wear indicator is reliable. It can be placed at one or multiple locations within the refractory lining. The wear indicator consists for example of bricks of the same material quality as the adjacent bricks of the lining, so that the determined degree of wear in a brickwork assembly according to the invention can be directly translated to the degree of wear of the adjacent lining.

In its most basic embodiment, the invention relates to a refractory ceramic brick assembly with the following characteristics:
A first row of at least two adjacent refractory ceramic bricks with a joint extending between them, which remains in its position and direction within the brickwork independently of the degree of wear of the bricks,
A second row of at least two refractory ceramic bricks which are, separated by a joint, arranged in a form-fitted manner adjacent to each other and where the side faces of the bricks adjacent to the joint form an angle a between 10° and 80°, or rather between 170° and 100° with the corresponding front faces of said bricks,
Upon relining of the brickwork the joint of the first row has the same direction, but is offset to the joint of the second row.

The term “direction of the joint” is describing the orientation of the joint, thus particularly vertically in the brickwork. The perspective on the joint(s) is always from the front, so from a furnace chamber, onto the brickwork.

An advantageous wear indicator is achieved when the joint of the first row extends at a distance to the joint of the second row which distance corresponds to a movement of the joint of the second row when the bricks of the second row are worn to a point where they should be replaced and the joint of the second row is aligned with the joint of the first row.

The brickwork which consists of at least two rows of at least two bricks each can be produced pre-assembled and be arranged at any required location within a refractory lining.

More than two bricks per row and more than two rows can be accommodated for. Further bricks in one row can be identical to the other bricks of that row or feature a different shape.

The bricks can be glued or mortared with each other. The joint width for any application can be adjusted accordingly. In order to ensure a repeatable detectability of the degree of wear, all joints between front faces and rear faces of the bricks should feature, as far as possible, a constant width.

The corresponding slanted side faces of the bricks of the second row can extend between the front and rear

faces of the bricks with identical orientation (at the same angle). They are particularly planar. However it is also possible to choose a different geometry, particularly in the rear part of the bricks, wherein the rear part of the brick then defines the residual thickness of the bricks which is required to ensure the security of the refractory lining. Generally, the geometry of the bricks in the (rear) part, which remains after the maximum tolerable degree of wear, is arbitrary.

As long as the front faces of the bricks are planar, the angle to the slanted side faces is clearly defined. In the case of curved or stepped front faces of the bricks, the angle is determined using an imaginary plane which extends between the left and right edge of the front face of the bricks.

The angle between the front faces of the bricks of the second row and the adjacent side faces is larger than 30° for the one brick, or rather less than 150° for the corresponding brick according to one embodiment. According to a further embodiment these values are <60° and >120°, where these values are each advantageously complemented to 180°+/−max. 10°.

The exact angle can be chosen for each application in such a way that the “moving joint” is aligned with a “fixed joint” between bricks of an adjacent row in order to identify a certain degree of wear.

The bricks of the first row can consist of two bricks of the same format, for example two cuboid bricks.

A third row of bricks can be added which is arranged in such a way that the second row is positioned between the first row and the third row.

The third row then consists of, for example, at least three refractory ceramic bricks, where a joint extends between adjacent bricks, keeping its direction independently of the degree of wear and upon

the relining of the brickwork the joints of the third row run in the same direction but offset to the joints of the first row and the second row.

In other words: the joints arranged within the third row of bricks, which keep their position and direction independently of the degree of wear, serve as additional markers for the wear of the bricks within the brickwork; accordingly the joints of the third row are also offset to the joint(s) of the first row.

This is further explained by the following embodiment.

The bricks of the third row can feature different formats, one slim brick (a brick with a narrow face) can for example be placed between two wide bricks.

The bricks of the third row can also feature a cuboidal shape; alternatively bricks can be used which, for example, feature a trapezoid shape in the plan (top) view. Other brick formats are possible, without leaving the inventive thought.

The arrangement of the bricks upon lining of the brickwork can for example be chosen in such a way that the joint within the second row aligns with a joint of the first row or the third row when the brickwork has reached ¼, ½ or ¾ of the wear at which the bricks should be replaced. Similarly the increments can be ⅓ or ⅔, or rather ⅕, ⅖, ⅗ or ⅘.

Further features of the invention will become apparent from the characteristics of the sub-claims as well as the further application documents.

In the following, the invention is further described by the means of one embodiment. The figures show—each in a schematic representation:

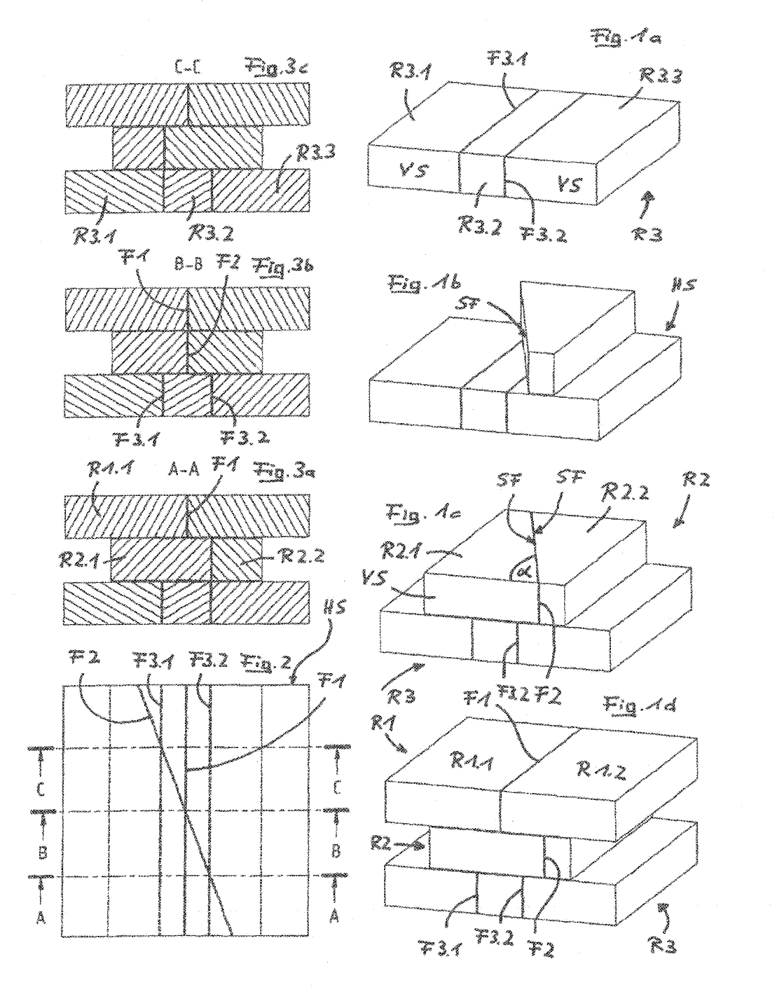

FIGS. 1a-d: The structure of a brickwork assembly with bricks in three rows on top of each other,

FIG. 2: a schematic representation of the joint progression in the brickwork

FIGS. 3a-c: Cross sections A-A, B-B, C-C according to FIG. 2

FIG. 1 shows a lower, third row R3 of the brickwork assembly, consisting of three adjacent cuboidal refractory bricks R3.1, R3.2, R3.3. Two outer bricks R3.1, R3.3 are wider, thus have a wider front face VS than the brick R3.2 placed in-between. Joints between the bricks R3.1, R3.2 and R3.2, R3.3 are labelled F3.1, F3.2. The joints F3.1, F3.2 extend linearly and at right angles between the front faces VS and the rear faces HS of the bricks R3.1, R3.2, R3.3. Independently of the wear of the bricks R3.1, R3.2, R3.3 (in the direction of the joint), the position of the joints 3.1, 3.2 remains the same.

A second row of bricks R2 is arranged on top of the third row of bricks R3, consisting of two bricks R2.1, R2.2 which together (arranged adjacent to each other) form a cuboidal shape and have corresponding slanted side faces SF.

The right side face SF of the brick R2.1 in FIG. 1c extends at an angle α of circa 45° to the front face VS, wherein a vertical joint F2 can be seen between the front faces VS of the bricks R2.1, R2.2 which extends offset (offset to the right) to the joint F3.2 when the brickwork is newly lined.

A first row of bricks R1 is arranged on top of the second row of bricks R2, consisting of two cuboidal refractory bricks R1.1, R1.2 which are of identical format and arranged in such away that the joint F1 which extends between the bricks R1.1, R1.2 extends exactly in the middle of the joints F3.1, F3.2 upon new lining.

In the plan (top) view this results in a joint progression as shown in FIG. 2. The FIGS. 3a-c show three degrees of wear according to FIG. 2.

It can be seen in FIG. 3a that the wear is at a stage where the joint F2 is aligned with the joint 3.2.

In FIG. 3b, the degree of wear of the bricks is at a stage that the joint F2 is aligned with joint F1, while in FIG. 3c the maximum degree of wear is shown where the joint F3 has “moved” so far to the left that it aligns with the joint F3.1 of the third row of bricks R3.

This corresponds to the wear up to the line C-C shown in FIG. 2. This is a signal to the personnel that the maximum degree of wear has been reached and the bricks have to be replaced.

All bricks within the displayed brickwork are MgO—C bricks and the joints are filled with a refractory mortar.

In a reduced embodiment the brickwork only consists of the bricks of the rows R1, R2 and the degree of wear shown in FIG. 3b corresponds to the degree of wear at which the bricks have to be replaced.

1. Refractory ceramic brick assembly, comprising the following features:
a) a first row (R1) of at least two refractory ceramic bricks (R1.1, R1.2) arranged adjacent to each other, between which a joint (f1) extends, which keeps its position and orientation within the brick composite independently of any wear of the bricks (R1.1, R1.2),
b) a second row (R2) of at least two refractory ceramic bricks (R2.1, R2.2), separated by a joint (F2) and arranged in a form-fit manner next to each other, wherein side surfaces (SF) of the bricks (R2.1, R2.2), adjacent to the joint (F2), define an angle a with corresponding front surfaces (VS) of said bricks (R2.1, R2.2) between 10° and 80° or between 170° and 100° respectively,
c) upon relining of the brick composite the joint (F1) of the first row (R1) extends with the same orientation but offset to the joint (F2) of the second row (R2).

2. Refractory ceramic brick assembly according to claim 1, wherein the joint (F1) of the first row (R1) extends at a distance to the joint (F2) of the second row upon relining of the brick composite, which distance corresponds to a displacement of the joint (F2) of the second row (R2), when the bricks (R2.1, R2.2) of the second row (R2) are worn to a degree that they must be replaced, and the joint (F2) of the second row (R2) is flush with the joint (F1) of the first row (R1).

3. Refractory ceramic brick assembly according to claim 1, wherein the side surfaces (SF) of the bricks (R2.1, R2.2) of the second row (R2), which are adjacent to the joint (F2), define an angle a larger than 30° or smaller than 150° with the corresponding front surfaces (VS) of said bricks (R2.1, R2.2).

4. Refractory ceramic brick assembly according to claim 1, wherein the side surfaces (SF) of the bricks (R2.1, R2.2) of the second row (R2), which are adjacent to the joint (F2), define an angle a smaller than 60° or larger than 120° with the corresponding front surfaces (VS) of said bricks (R2.1, R2.2).

5. Refractory ceramic brick assembly according to claim 1, wherein the first row (R1) is made of two bricks (R1.1, R1.2) of same format.

6. Refractory ceramic brick assembly according to claim 1 with a third row (R3) of at least three refractory ceramic bricks (R3.1, R3.2, R3.3), with a joint (F3.1, F3.2) between adjacent bricks (R3.1, R3.2; R3.2, R3.3), which keep their position and orientation independently of any wear of the bricks (R3.1, R3.2, R3.3) and wherein, upon relining of the brick composite, the joints (F3.1, F3.2) of the third row (R3) extends with the same orientation but offset to the joints (F1, F2) of the first row (R1) and the second row (R2).

7. Refractory ceramic brick assembly according to claim 6, wherein the second row (R2) extends between the first row (R1) and the third row (R3).

8. Refractory ceramic brick assembly according to claim 6, wherein the bricks (R3.1, R3.2, R3.3) of the third row (R3) have different formats.

9. Refractory ceramic brick assembly according to claim 6, wherein the third row (R3) features a brick (R3.2) with a front surface (VS) of reduced width between bricks (R3.1, R3.3) with a front surface of larger widths.

10. Refractory ceramic brick assembly according to claim 1, wherein the bricks (R1.1, R1.2) of the first row (R1) have a cuboic shape.

11. Refractory ceramic brick assembly according to claim 1, wherein the bricks (R3.1, R3.2, R3.3) of the third row (R3) have a cuboic shape.

12. Refractory ceramic brick assembly according to claim 6 wherein the bricks (R1.1, R1.2; R2.1, R2.2; R3.1, R3.2, R3.3), upon relining, are arranged in such a way that the joint (F2) of the second row (R2) is flush with a joint (F1, F3.1, F3.2) of the first row (R1) or the third row (R3), when the brick composite has reached ¼, ½ or ¾ of its maximum wear, at which the bricks (R1.1, R1.2; R2.1, R2.2; R3.1, R3.2, R3.3) are to be replaced.

13. Refractory ceramic brick assembly according to claim 6 wherein the bricks (R1.1, R1.2; R2.1, R2.2; R3.1, R3.2, R3.3), upon relining, are arranged in such a way that the joint (F2) of the second row (R2) is flush with a joint (F1, F3.1, F3.2) of the first row (R1) or the third row (R3), when the brick composite has reached ⅓ or ⅔ of its maximum wear, at which the bricks (R1.1, R1.2; R2.1, R2.2; R3.1, R3.2, R3.3) are to be replaced.
